(19) United States
(12) Patent Application Publication
(10) Pub. No.: US 2026/0233845 A1
(43) Pub. Date: Aug. 13, 2026

(54) INLINE ELECTRO-MECHANICAL POWER CONVERTER, AND AIRCRAFT HAVING THE SAME

(71) Applicant: New Horizon Aircraft Ltd., Lindsay (CA)

(72) Inventors: Geoffrey Kirk CREELMAN, Haliburton (CA); Eric Brian ROBINSON, Kirkfield (CA)

(21) Appl. No.: 19/053,102

(22) Filed: Feb. 13, 2025

(51) Int. Cl. B64D 27/357; B64C 29/00; B64D 35/00; H02K 7/18

(52) U.S. Cl. CPC B64D 27/357; B64C 29/0091; B64D 35/00; H02K 7/1807

(57) ABSTRACT

An inline electro-mechanical power converter and an aircraft having the same, including a fuel engine, a gearbox for converting a first torque force generated by the fuel engine into a second greater torque force, a power output shaft to transmit the second torque force to a thrust force generator, a set of coil assemblies secured to a frame in an annular array, a first magnet support structure extending radially from at least one of the power output shaft and the thrust force generator and configured to rotate therewith, and a first set of magnets positioned radially on the first magnet support structure and adjacent to the set of coil assemblies to generate an electric current in the set of coil assemblies when the magnet support structure is rotated relative to the set of coil assemblies, wherein the set of coil assemblies is connectable to a battery bank for recharging it.

### FIELD

The invention relates to electric power generation, and, more particularly, to an inline electro-mechanical power converter for an aircraft, and an aircraft having the same.

### BACKGROUND OF THE DISCLOSURE

The aviation industry has been making a long and steady move toward electrification. What once was a largely mechanical machine has grown into an electrically power-hungry vehicle. Increased electrical needs for avionics, electrically driven hydraulics, electrical climate control, radar, onboard passenger comforts, and the driving of small but powerful electrical motors has been the continuing trend.

This has been seen in both large and small aircraft but even more recently with the introduction of electric vertical take-off and landing (eVTOL) designs that require increases of electrical power of several orders of magnitude. This power is needed for charging massive battery banks and driving ultra-powerful and compact motors.

Despite this increased demand for electrical power, aircraft engines have not changed in step. This is due to the large cost and effort needed by manufacturers to upgrade such a complex component as an engine in such a heavily regulated industry.

A typical aircraft engine has a very high output “power shaft” to supply power to the main propulsion systems'propellor or fan. It also has a low-output “accessory drive” that is used to provide small amounts of power for ancillary devices such as an engine starter and light draw items. In some cases, a small generator is hung from the “power drive” side (that is, adjacent to the motor) to supplement electrical power output but it is generally minimal in capacity and difficult to install due to space requirements.

### SUMMARY OF THE DISCLOSURE

In an aspect of the present disclosure, there is provided an inline electro-mechanical power converter, comprising: a first magnet support structure connectable to at least one of an output shaft driven by an engine and a thrust force generator, the first magnet support structure extending radially from the least one of the output shaft and the thrust force generator and being configured to rotate directly with the at least one of the output shaft or the thrust force generator when the first magnet support structure is connected to the at least one of the output shaft and the thrust force generator; a first set of magnets positioned radially on the first magnet support structure; and a set of coil assemblies secured to a coil support frame in an annular array, the set of coil assemblies being positioned adjacent to the first set of magnets, the first set of magnets generating an electric current in the set of coil assemblies when the magnet support structure is rotated relative to the set of coil assemblies; wherein the set of coil assemblies is connectable to a load for providing power to the load when the first magnet support structure is rotated relative to the set of coil assemblies.

In some or all embodiments of the first aspect, the first magnet support structure is configured to be secured to the output shaft.

In some or all embodiments of the first aspect, the inline electro-mechanical power converter includes a set of cooling fans positioned to cool the set of coil assemblies.

In some or all embodiments of the first aspect, the thrust force generator is a propellor.

In some or all embodiments of the first aspect, the load is a battery bank.

In some or all embodiments of the first aspect, the set of coil assemblies includes two or more subsets of coil assemblies of the set of coil assemblies, each of the subset of coil assemblies of the set of coil assemblies being configured to independently connect to the battery bank to recharge the battery bank in a recharging mode.

In some or all embodiments of the first aspect, a first subset of coil assemblies is configured to generate more current and/or voltage than a second subset of coil assemblies.

In some or all embodiments of the first aspect, each subset of coil assemblies in the set of coil assemblies consists of one coil assembly.

In some or all embodiments of the first aspect, the set of cooling fans includes two or more subsets of cooling fans, each subset of cooling fans being powered by a corresponding subset of coil assemblies that the subset of cooling fans is positioned to cool.

In some or all embodiments of the first aspect, the load is a battery bank.

In some or all embodiments of the first aspect, the inline electro-mechanical power converter is configured to provide power to the battery bank in a recharging mode, and, in a drive mode, is configured to energize the set of coil assemblies to apply a torque force on the output shaft.

In some or all embodiments of the first aspect, the forward power drive is configured to energize the set of coil assemblies to apply a torque force on the power output shaft to start the engine.

In some or all embodiments of the first aspect, the load is an accessory.

In a second aspect of the present disclosure, there is provided an aircraft, comprising: an inline electro-mechanical power converter, comprising: a first magnet support structure connected to at least one of an output shaft driven by an engine and a thrust force generator, the first magnet support structure extending radially from the least one of the output shaft and the thrust force generator and being configured to rotate directly with the at least one of the output shaft or the thrust force generator; a first set of magnets positioned radially on the first magnet support structure; and a set of coil assemblies secured to a coil support frame in an annular array, the set of coil assemblies being positioned adjacent to the first set of magnets, the first set of magnets generating an electric current in the set of coil assemblies when the magnet support structure is rotated relative to the set of coil assemblies; wherein the set of coil assemblies is connected to a load for providing power to the load when the first magnet support structure is rotated relative to the set of coil assemblies.

In some or all embodiments of the second aspect, the first magnet support structure is secured to the output shaft.

In some or all embodiments of the second aspect, the forward power drive includes a set of cooling fans positioned to cool the set of coil assemblies.

In some or all embodiments of the second aspect, the thrust force generator is a propellor.

In some or all embodiments of the second aspect, the load is a battery bank.

In some or all embodiments of the second aspect, the set of coil assemblies includes two or more subsets of the set of coil assemblies, each of the subset of the set of coil assemblies independently connecting to the battery bank to recharge the battery bank in a recharging mode.

In some or all embodiments of the second aspect, each subset in the set of coil assemblies consists of one coil assembly.

In some or all embodiments of the second aspect, a first subset of coil assemblies is configured to generate more current and/or voltage than a second subset of coil assemblies.

In some or all embodiments of the second aspect, the set of cooling fans includes two or more subsets of cooling fans, each subset of cooling fans being powered by a corresponding subset of coil assemblies that the subset of cooling fans is positioned to cool.

In some or all embodiments of the second aspect, the load is a battery bank, and rotation of the first magnet support structure relative to the set of coil assemblies recharges the battery bank in a recharging mode, the aircraft further comprising a vertical thrust fan that is electrically powered by the battery bank in a drive mode.

In some or all embodiments of the second aspect, the battery bank is smaller in capacity than required to power the vertical thrust fan during both take-off and landing.

In a third aspect of the present disclosure, there is provided an inline electro-mechanical power converter, comprising: a first magnet support structure connectable to at least one of an output shaft driven by an engine and a thrust force generator, the first magnet support structure extending radially from the least one of the output shaft and the thrust force generator and being configured to rotate directly with the at least one of the output shaft or the thrust force generator when the first magnet support structure is connected to the at least one of the output shaft and the thrust force generator; a first set of magnets positioned radially on the first magnet support structure; and a set of coil assemblies secured to a coil support frame in an annular array, the set of coil assemblies being positioned adjacent to the first set of magnets, the set of coil assemblies including two or more subsets of the set of coil assemblies, each of the subset of the set of coil assemblies being configured to independently connect to one or more loads, the first set of magnets generating an electric current in each of the two or more subsets of the set of coil assemblies when the magnet support structure is rotated relative to the two or more subsets of the set of coil assemblies; wherein the two or more subsets of the set of coil assemblies are configured to provide power to the load when the first magnet support structure is rotated relative to the set of coil assemblies in a recharging mode.

In some or all embodiments of the third aspect, each subset of coil assemblies in the set of coil assemblies consists of one coil assembly.

In some or all embodiments of the third aspect, a first subset of coil assemblies is configured to generate more current and/or voltage than a second subset of coil assemblies.

In some or all embodiments of the third aspect, the first magnet support structure is configured to be secured to the output shaft.

In some or all embodiments of the third aspect, the inline electro-mechanical power converter includes a set of cooling fans positioned to cool the set of coil assemblies

In some or all embodiments of the third aspect, the set of cooling fans includes two or more subsets of cooling fans, each subset of cooling fans being powered by a corresponding subset of coil assemblies that the subset of cooling fans is positioned to cool.

Other technical advantages may become readily apparent to one of ordinary skill in the art after review of the following figures and description.

### BRIEF DESCRIPTIONS OF THE DRAWINGS

For a better understanding of the embodiment(s) described herein and to show more clearly how the embodiment(s) may be carried into effect, reference will now be made, by way of example only, to the accompanying drawings in which:

FIG. 1 is a schematic side elevation view of an eVTOL aircraft in accordance with some exemplary embodiments of the present disclosure.

FIG. 2 is a top, rear, left perspective view of a forward power drive of the eVTOL aircraft of FIG. 1.

FIG. 3 is a schematic view of the forward power drive of FIG. 2 connected to a battery bank.

FIG. 4 is a top, rear, left perspective view of an inline electro-mechanical power converter of the forward power drive of FIG. 2.

FIG. 5 is a top, rear, left partial-section view of the inline electro-mechanical power converter of FIG. 4.

FIG. 6 is a side elevation section view of the inline electro-mechanical power converter of FIG. 4 along 6-6.

FIG. 7 is a rear elevation section view of the inline electro-mechanical power converter of FIG. 4 along 7-7.

FIG. 8 is a schematic side elevation view of an aircraft in accordance with some exemplary embodiments of the present disclosure.

FIG. 9 is a schematic side elevation view of an eVTOL aircraft in accordance with some embodiments of the present disclosure.

FIG. 10A is a rear elevation section view of the inline electro-mechanical power converter in accordance with some embodiments of the present disclosure.

FIG. 10B is a rear elevation section view of the inline electro-mechanical power converter in accordance with some embodiments of the present disclosure.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness. Additionally, several examples have been described throughout this specification. Any features from any example may be included with, a replacement for, or otherwise combined with other features from other examples.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

The description of the inline electro-mechanical power converter that follows, and the embodiments described therein, are provided by way of illustration of an example, or examples, of particular embodiments of the principles, aspects or features of the invention. These examples are provided for the purposes of explanation, and not of limitation, of those principles and of the invention. In the description, like parts are marked throughout the specification and the drawing with the same respective reference numerals.

The terminology used in this specification is thought to be consistent with the customary and ordinary meaning of those terms as they would be understood by a person of ordinary skill in the aircraft industry in North America. The Applicant expressly excludes all interpretations that are inconsistent with this specification, and, in particular, expressly excludes any interpretation of the claims or the language used in this specification such as may be made in the USPTO, or in any other patent office, other than those interpretations for which express support can be demonstrated in this specification or in objective evidence of record, (for example, earlier publications by persons not employed by the USPTO or any other patent office), demonstrating how the terms are used and understood by persons of ordinary skill in the art, or by way of expert evidence of a person or persons of at least 10 years of experience in the aircraft industry in North America or equivalent.

In terms of general orientation and directional nomenclature, for aircraft described herein, the longitudinal or lengthwise direction is defined as being coincident with the fore-and-aft direction of flight of the aircraft in forward, straight, and level flight. In the case of a fixed airfoil aircraft, the longitudinal direction is parallel to the rolling direction of the wheeled landing gear. The leading direction, or leading edge lies toward the forward direction of travel; the rearward or trailing direction or trailing edge is oriented away from (i.e., backwards relative to) the normal direction of advance of the aircraft in forward flight. Unless otherwise noted, vertical, or upward and downward, are terms that use the landing terrain as a datum. Unless otherwise noted, “vertical” or “vertically” are intended to also include “substantially vertical” and “substantially vertically” respectively. In the context of the aircraft as a whole, the terms cross-wise, lateral, spanwise, or laterally outboard, or transverse, or transversely outboard refer to a distance or orientation perpendicular or substantially perpendicular relative to the longitudinal centreline of the fuselage. The commonly used engineering terms “proud”, “flush”, and “shy” may be used herein to denote items that, respectively, protrude beyond an adjacent element, are level with an adjacent element, or do not extend as far as an adjacent element, the terms corresponding conceptually to the conditions of “greater than”, “equal to”, and “less than”.

The directions correspond generally to a Cartesian frame of reference in which the x-direction is longitudinal, the y-direction is lateral, and the z-direction is vertical. Pitching motion is angular motion of the aircraft about a horizontal axis perpendicular to the longitudinal direction. Yawing is angular motion about a vertical axis. Roll is angular motion about the longitudinal axis. Given that the aircraft described herein may tend to have a longitudinal axis of symmetry, a description of one half of the aircraft may generally also be intended to describe the other half as well, allowing for differences between right hand and left-hand parts. Also, it may be taken as a default that the basic structure of the aircraft is of aluminum fabrication with a reinforced composite surface skin, unless otherwise shown in the illustrations or indicated in the text. Other materials such as stainless steel or wood might be also used for some components.

In this discussion it may be understood that persons of ordinary skill are familiar with the aircraft construction and maintenance in North America, and may include aircraft maintenance engineers having knowledge of US Department of Transportation, Federal Aviation Administration publication EA-AC 43.13-1A & 2A “Acceptable Methods, Techniques and Practices, Aircraft Inspection and Repair”, or any successor publication thereof, as updated at the date of priority filing of this specification. This specification is to be interpreted in a manner consistent with that publication.

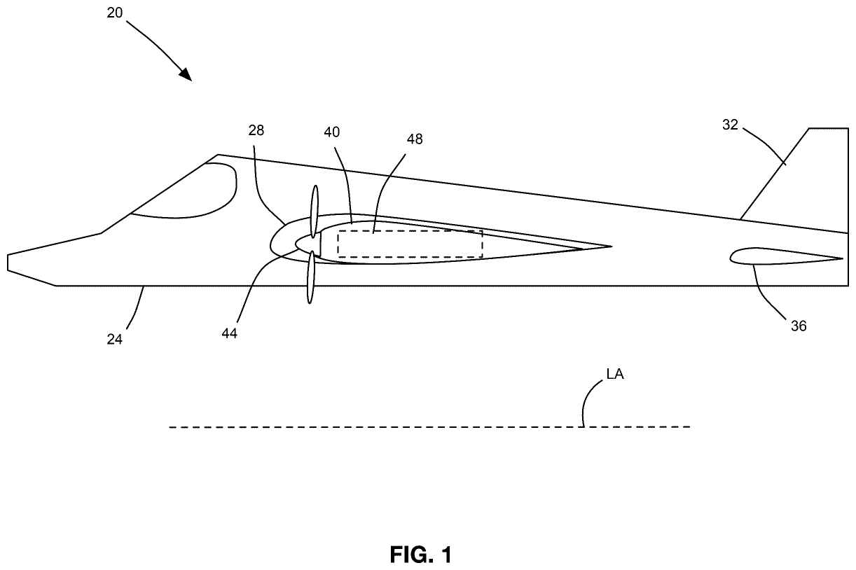

FIG. 1 shows an aircraft 20 in accordance with some embodiments of the disclosure. The aircraft 20 is an eVTOL aircraft, meaning it is capable of taking off and landing vertically or substantially vertically. Although principles, aspects, and features of the invention herein may be applied to other eVTOL aircraft, as may be appropriate in respect to configurations wherein there are a plurality of vertically or substantially vertically-thrusting fans located in the airfoils, it may be taken that in the embodiment illustrated in FIG. 1, the aircraft 20 is of a high-wing eVTOL configuration with a pair of airfoils optimized for efficient forward flight.

The aircraft 20 has a fuselage 24 that extends along a longitudinal axis LA. Two airfoils in the form of wings 28 extend from the fuselage 24. In this embodiment, the two wings 28 sweep in a rearward direction, but in other embodiments, the wings can extend substantially laterally or sweep in a forward direction. A tail structure connected to the fuselage 24 includes a vertical stabilizer 32 and a pair of horizontal stabilizers 36.

Along each wing 28 are one or more forward power drives 40 that provide forward thrust by propelling the aircraft forward in the air. The aerodynamics of the wings 28 generates lift as the aircraft 20 travels forward through the air. Each of the forward power drives 40 generates forward thrust by rotation of thrust force generator in the form of a propellor 44 using a motor that is powered by an aviation fuel. Aviation fuel is typically a petroleum-based fuel.

In addition, each of the wings 28 includes one or more vertical thrust fans 48 that are positioned within the wing 28. The vertical thrust fans 48 are electrically powered by one or more battery banks and generate lift without the need to propel the aircraft 20 forward through the air. As used herein, the term “battery bank” may alternatively encompass both a single battery bank or two or more battery banks for simplicity purposes.

During a normal flight, the vertical thrust fans 48 are powered by the battery bank to lift the aircraft 20 from a stationary position on the ground or other suitable horizontal surface. The vertical thrust fans 48 continue to operate to lift the aircraft 20 until a desired altitude is reached. At this point, the forward power drives 40 are initialized and commence producing forward thrust to move the aircraft 20 forward through the air. As the aircraft 20 accelerates to a sufficient forward speed to generate sufficient lift via the wings 28 to at least partially counter the force of gravity on the aircraft 20, the power provided to the vertical thrust fans 48 is ramped down, thereby reducing their rotational speed and the vertical thrust they provide. Once the aircraft 20 has sufficient forward speed to generate sufficient lift to maintain the aircraft 20 in the air, the power provided to the vertical thrust fans 48 is cut off.

The vertical thrust fans 48 are typically covered during normal forward flight in order to improve the aerodynamics of the wings 28 and reduce drag. In some embodiments, the covers can be a set of louvers that pivot to expose or cover the vertical thrust fans 48. In other embodiments, the covers can be sliding panels.

During the landing process, the forward airspeed of the aircraft 20 is slowed down, resulting in reduced lift from the aerodynamics of the wings 28. At the same time, the vertical thrust fans 48 are spun up to generate lift to compensate for the reduced lift from the wings 28. Forward thrust can then be completely shut off as the vertical thrust fans 48 take over to provide lift to maintain the altitude of the aircraft 20. The vertical thrust fans 48 can then be controlled to lower the aircraft 20 towards the ground to land.

An issue with conventional configurations is that, in order to provide sufficient electrical power to energize vertical thrust fans for both take-off and landing, the battery bank has to be very large, which adds significant weight of an aircraft. As a result, the efficiency of forward power drives is reduced, resulting in reduced range and/or increased fuel consumption and/or reduced payload capacity.

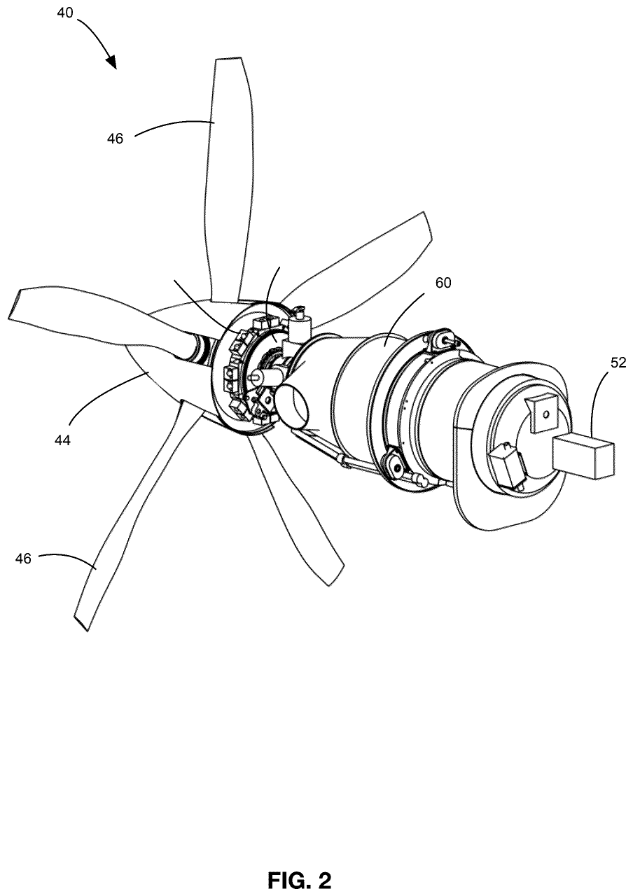

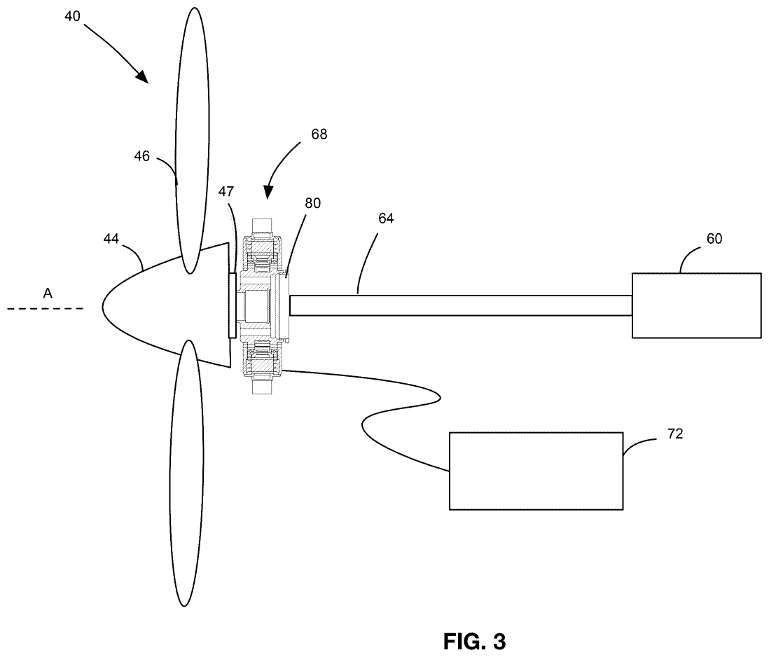

FIGS. 2 and 3 show the forward power drive 40 having a power output shaft 64 that is couplable to a fuel engine 60. The fuel engine 60 can be any conventional kind of motor for driving a propellor using fuel combustion, and is typically powered by an aviation fuel that is generally petroleum-based. As used herein, “fuel engine” can include any gear boxes and intermediate shafts coupled to the power output shaft 64 to drive rotation of the power output shaft inline with the rotation of the fuel engine. A “power output shaft”, as used herein, refers to the shaft that directly transfers rotation from the fuel engine 60 to a propellor or other thrust force generator, and is robust enough to extract the full inline power generated by an engine. The term “inline”, as used herein, refers to the path of transfer of power from the fuel engine to the power output shaft and thrust force generator. The power output shaft 64 and integral output flange 80 is coupled to the propellor hub 44 and its integral propeller mounting flange 47 via shared mounting to the rigid coupler 84. The rigid coupler 84 is capable of transferring the full output power from the motor 60 to the propellor hub 44. The propellor hub 44 has a set of propellor blades 46 that are shaped and/or angled to generate thrust in an axial direction along the axis A of the power output shaft 64.

In addition, the rigid coupler 84 is coupled to an inline electro-mechanical power converter 68 as described herein. The inline electro-mechanical power converter 68 is connectable to one or more battery banks 72, and is shown connected to the battery bank 72 in FIG. 3. Electrical power is generated by the rotation of the power output shaft 64 and passed to the one or more battery banks 72 to recharge them in a recharging mode.

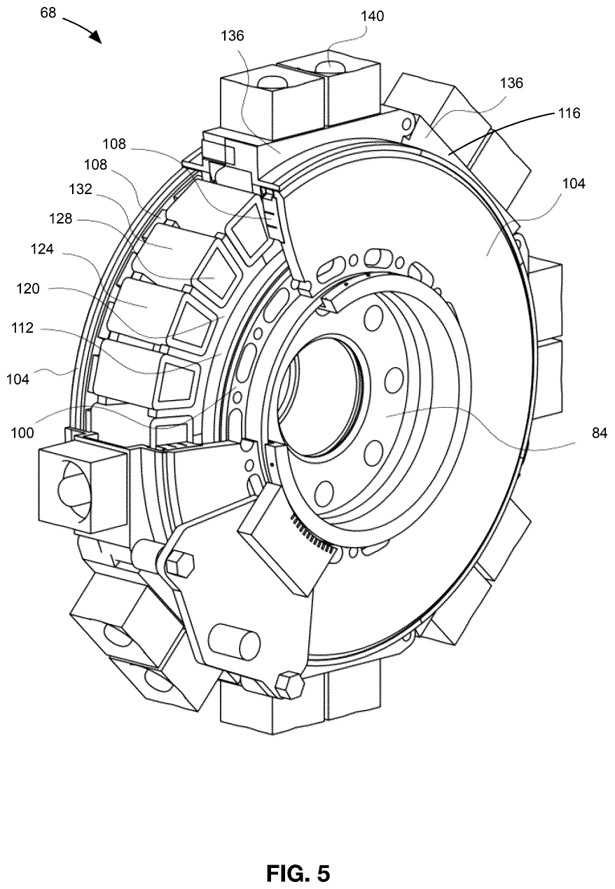

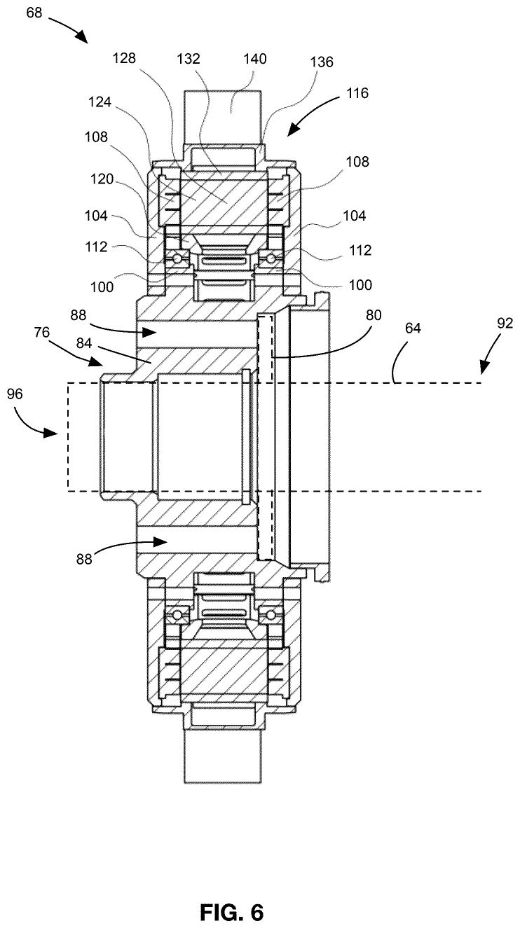

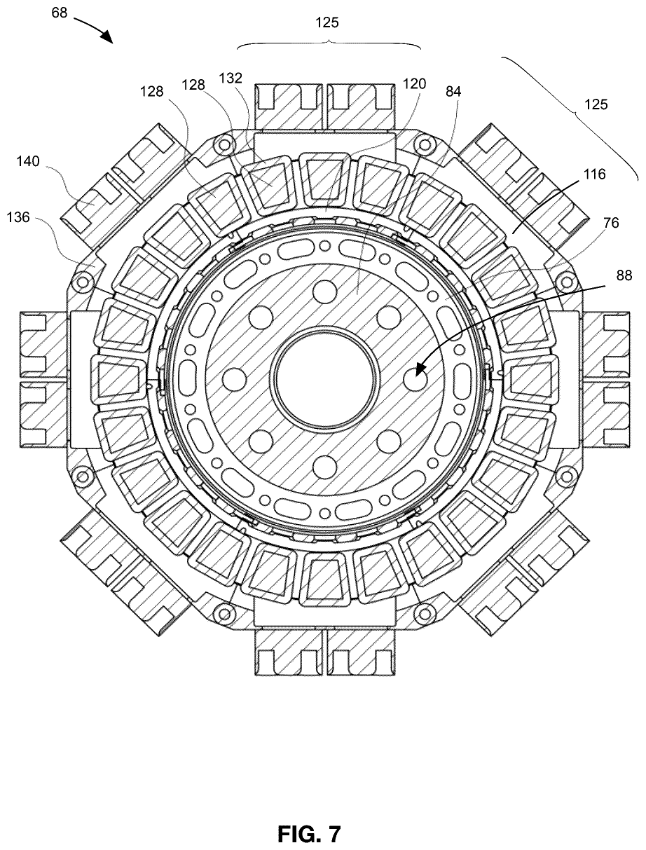

Now with reference to FIGS. 2 to 7, the inline electro-mechanical power converter 68 includes a rotating assembly 76 that is secured to a mounting flange 80 of the power output shaft 64 via a rigid coupler 84. The radial flange 80 has a number of apertures through which bolts (not shown for simplicity) are fit and secured in corresponding apertures 88 in the rigid coupler 84. The rigid coupler 84 may contain one or more sealed passageways so that hydraulic fluid can pass from the engine to the propeller as is typical in the industry. In addition, the rigid coupler 84 may contain a wire and rotating brush system for electrical connection to the propeller as is typical in the industry. Raised radial flanges 100 of the rigid coupler 84 accept magnet support structures in the form of drive discs 104 which can be largely similar. The drive discs 104 extend radially from the power output shaft 64 and are mounted to the radial flanges 100 using an array of fasteners (not shown) positioned through an array of radial holes 155. An array of magnets 108 is positioned radially and mounted on the inside face of each of the drive discs 104. In other embodiments, the magnet support structures can assume various other forms that extend radially relative to the output shaft.

Support bearings 112 connect the rotating assembly 76 to the non-rotating “hub assembly” 116 and provide axial restraint and concentricity while allowing low friction rotational motion between the two assemblies 76, 116.

The non-rotating hub assembly 116 includes a frame in the form of a hub support 120 which interfaces with the support bearings 112. The hub support 120 contains mounting provisions for an annular array of coil assemblies 124. The coil assemblies 124 include a core 128 and conductive wire winding 132 placed around the core 128. Twenty-four coil assemblies 124 have been depicted in this embodiment however any number of coil windings may be chosen depending on the electrical design requirements. The coil assemblies 124 are aligned axially so that each end of a coil assembly 124 is adjacent to and faces a corresponding magnet array 108 that is mounted on the drive discs 104. Rotation of the power output shaft 64 and the coupled drive discs 104 with the magnet arrays 108 secured to them relative to the coil assemblies 124 induces a current in the wire windings 132 of the coil assemblies 124. The drive discs 104 rotate directly (i.e., at the same revolutions per minute) with the power output shaft 64 as they are secured to the power output shaft 64 and there is no gearing between them. While the frame is shown supporting the coil assemblies 124 along an internal circumference, in other embodiments, the frame can support the coil assemblies in other manners. For example, the frame can support the coil assemblies along the outer circumference. Also, in some embodiments, it may be possible to use only a set of magnets positioned radially along one side of the set of coil assemblies.

Industry standard winding schemes for the coil assemblies 124 may be typical of any three-phase permanent magnet motor winding. In some embodiments, all twenty-four wire windings 132 operate as individual winding circuits. Individual control of each wire winding 132 is favoured in some applications so that unique drive electronics can be employed, and multiple independent voltage taps can be provided.

Two or more subsets 125 of the coil assemblies 124 are separately electrically connected to the battery bank 72 to recharge it. Each of the subsets of the coil assemblies 124 can include one or more coil assemblies 124. In the particular illustrated configuration, there are eight subsets 125 of coil assemblies 124, with three coil assemblies 124 in each subset 125. In this manner, while failure of one or more of the coil assemblies 124 can occur, the redundancy of the coil assemblies 124 can ensure that electric power generation for recharging the battery bank 72 continues to occur, even if slightly reduced as a result of the one or more failures.

Further, the set of coil assemblies 124 has the capability to produce multiple isolated outputs from a single inline electro-mechanical power converter, depending on its configuration. In this embodiment there are 24 segments of the inline electro-mechanical power converter 68 that can be individually accessed to produce the required voltages and/or phase. This reduces the need for tertiary power conversion and maintains power isolation between multiple sources and increases redundancy. This reduces the wiring size of the feeder cables from the inline electro-mechanical power converter, and can eliminate secondary power conversion and isolation electronics.

An outer cover 136 supports the coil assemblies 124 and is configured to support an array of cooling fans 140 that are positioned to direct cooling air directly across the coil assemblies 124 to cool them. In various embodiments, each of the cooling fans 140 can be powered by the battery bank 72, by may be coupled to one or more coil assemblies 124 (such as those particular coil assemblies 124 that the cooling fan 140 is positioned to cool), or any other configuration for powering the cooling fans 140 can be employed. In some exemplary embodiments, subsets of one or more of the cooling fans are positioned to cool corresponding subsets 125 of coil assemblies 124, and may be powered by the particular subset 125 of the coil assemblies 124. In other exemplary embodiments, subsets of the cooling fans can be independently powered, such as by the battery bank so that the coil assemblies 124 can be cooled even if the engine is not operating. As illustrated, subsets of two cooling fans 140 are positioned to cool each subset 125 of three coil assemblies 124. In this manner, energy can be conserved by not powered cooling fans for cooling assemblies that have failed. In other configurations, the number of cooling fans in the subset of cooling fans and the number of coil assemblies in the subset of coil assemblies can be altered to suit the needs of a particular design.

The cooling fans 140 employ air as a cooling medium for the array of coil assemblies 124. This configuration is advantageous in an electric aircraft as the power is readily available, creating a simplified cooling architecture for the electro-mechanical power converter. The inline electro-mechanical power converter could be liquid/air cooled, however this increases system complexity, adding components such as pipes, fluids, pumps, radiators.

The complete non-rotating hub assembly 116 is restrained from rotation using a torque arresting arm that is connected to a non-rotating portion of the fuel engine 60 or other non-rotating reference point.

Operation of the aircraft 20 will now be described with reference to FIGS. 1 to 7. During take-off, the vertical thrust fans 48 are exposed and powered by the battery bank 72 to lift the aircraft 20 to a desired altitude before the forward power drives 40 are powered up to provide forward momentum, with the amount of power being provided to the vertical thrust fans 48 being reduced as the aircraft 20 gains forward momentum from the thrust provided by the forward power drives 40. Once the lift afforded by the vertical thrust fans 48 is no longer required, the vertical thrust fans 48 are powered off and covered to improve the aerodynamics of the wings 28.

Similarly, during landing, as the aircraft 20 approaches a desired landing location, the power provided to the forward power drives 40 is cut, the vertical thrust fans 48 are exposed and powered up to provide lift. The vertical thrust fans 48 are throttled to reduce the lift provided, enabling the aircraft 20 to float towards and land on the ground or other landing surface.

With a conventional configuration, the battery bank needs to be relatively large as no significant recharging of the battery bank occurs during flight. As the aircraft 20 captures electric power via the inline electro-mechanical power converter 68 during regular forward flight, the battery bank 72 can be reduced in size as it can be recharged so that the aircraft 20 can safely land using the vertical thrust fans 48. Thus, the battery bank 72 may be provisioned with a capacity that is less than the power required for both take-off and landing using the vertical thrust fans 48.

In an example, assuming that the electrical power required for take-off using the vertical thrust fans 48 is 35 kilowatt-hours and the electrical power required for landing using the vertical thrust fans 48 is 28 kilowatt-hours, the battery bank 72 can have a lesser charge capacity of 50 kilowatt-hours. After take-off, the charge in the battery bank 72 would be 15 kilowatt-hours. During normal forward flight (that is, powered by the forward power drives 40 and unpowered by the vertical thrust fans 48), the battery bank 72 can be charged back up above 28 kilowatt-hours, thus having sufficient charge to power the vertical thrust fans 48 for descent.

Further, in a drive mode, the inline electro-mechanical power converter 68 can be used to apply a torque force on the power output shaft 64 or the propellor 44 to act as a starter motor for the fuel engine 60, thereby negating the need to deploy a dedicated starter motor. As a result, weight savings can be achieved.

Still further, in a drive mode, the inline electro-mechanical power converter 68 can be used to provide additional torque on the power output shaft 64 or the propellor 44.

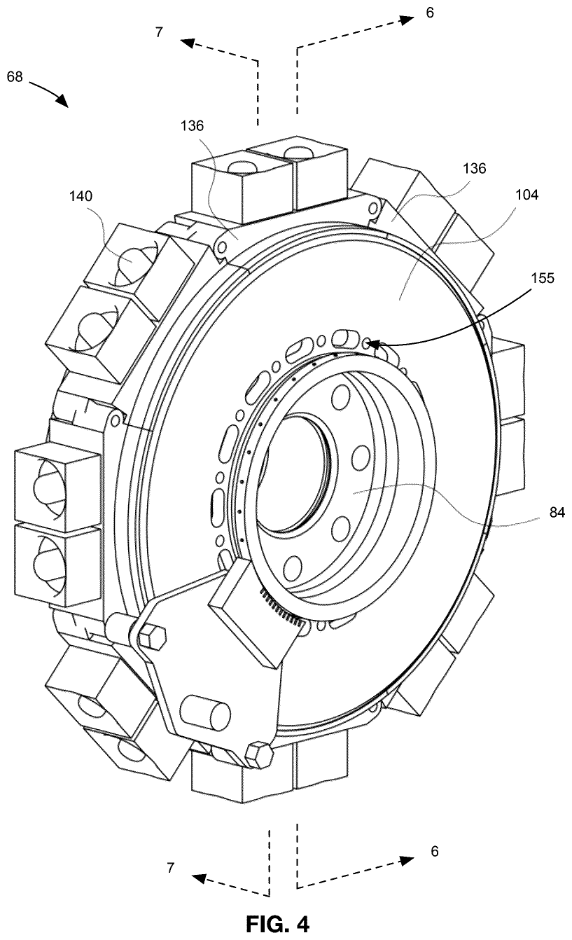

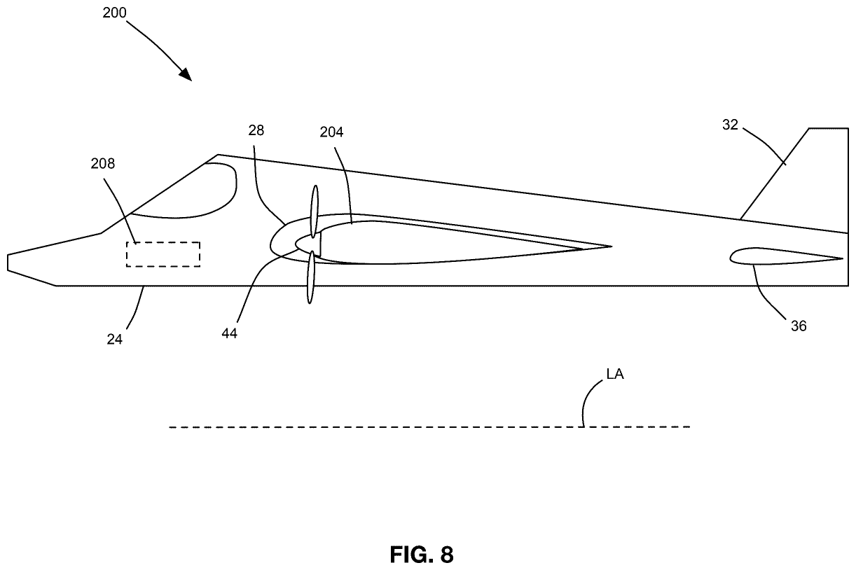

FIG. 8 shows an aircraft 200 in accordance with some exemplary embodiments of the present disclosure. The aircraft 200 is similar to the aircraft 20 of FIGS. 1 and 4, and like elements are numbered similarly. The aircraft 200 has a forward power drive 204 that is similar to the forward power drive 40 of FIGS. 1 and 3, but may or may not include a battery bank. In addition, the aircraft 200 includes a load in the form of one or more accessories 208 that receive power from the inline electro-mechanical power converter of the forward power drive 204 to power the accessory 208. In one example, the accessories 208 include a high-power radar unit. In another example, the accessories 208 include geophysical survey equipment. By connecting the inline electro-mechanical power converter for direction rotation with the output shaft, greater power can be generated and transferred to the accessories 208. In some scenarios, subsets of the coil assemblies may be connected to separate ones of the accessories 208 (and a battery bank where included) to power them.

The aircraft 200 does not employ vertical thrust fans like the aircraft 20 of FIG. 1, and instead relies upon the forward thrust provided by the propellor 44 to drive the aircraft 200 forward with sufficient velocity to generate lift. Some of the greatest torque requirements for the aircraft 200 occur during take-off. The inline electro-mechanical power converter can be employed to provide additional torque on the output shaft or propellor to assist the engine at this time, thereby easing stress on the engine, and or reducing the torque requirements of the engine.

The power drives described above inject more power into the driveline from a battery bank and/or extract power from the driveline for delivery to a load, such as a battery bank or an accessory.

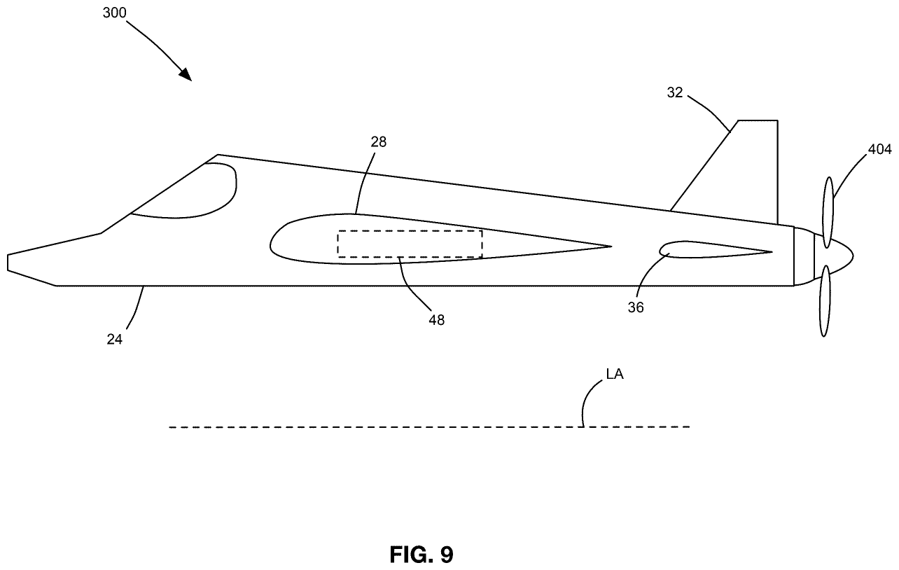

FIG. 9 shows an aircraft 300 in accordance with some exemplary embodiments of the present disclosure. The aircraft 300 is similar to the aircraft 20 of FIGS. 1 and 3, and like elements are numbered similarly. In particular, the aircraft 300 has a forward power drive that is similar to the forward power drive 40 of FIGS. 1 and 3, except that the forward power drive is inverted to drive a rearward-positioned pusher propellor 304. An inline electro-mechanical power converter of the forward power drive can be connected to a load such as a battery bank, one or more accessories, etc. The same principles apply in this illustrated example as to the illustrated example of FIGS. 1 and 3.

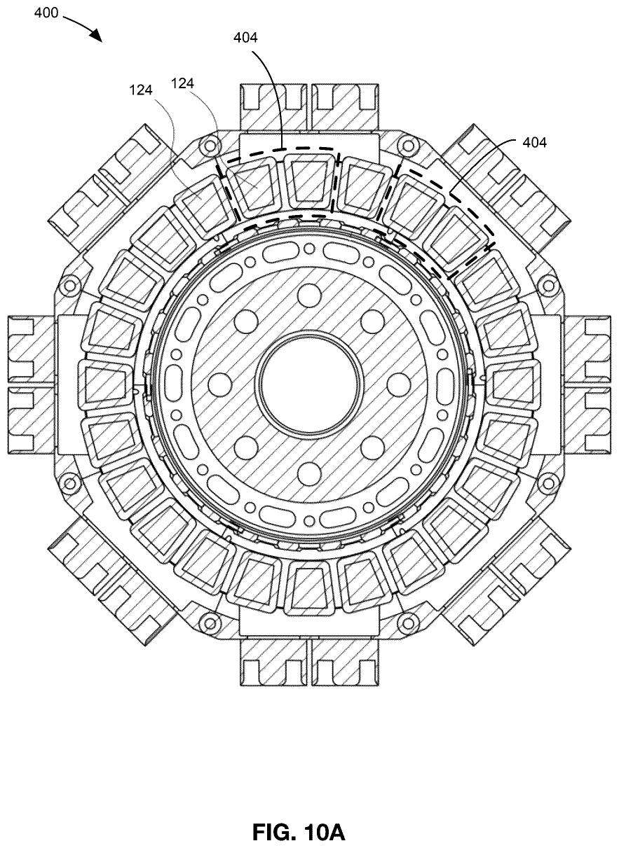

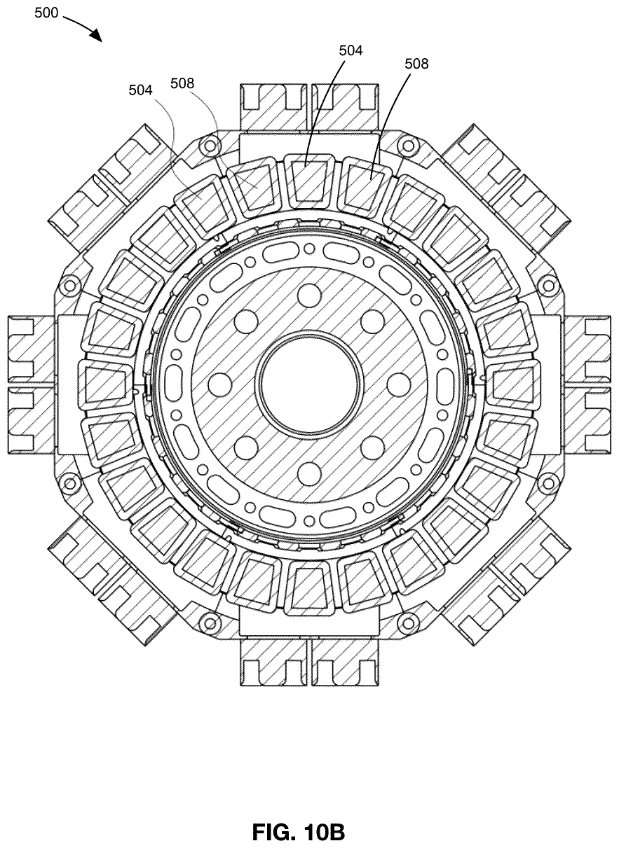

FIG. 10A shows a configuration for an inline electro-mechanical power converter 400 in accordance with some embodiments, wherein sets of two coil assemblies 124 are grouped together 404 and electrically connected in series to a load to provide power in tandem. Other coil assemblies 124 are electrically connected singly to the load. In this manner, multiple voltages and/or currents can be generated using the inline electro-mechanical power converter. As will be appreciated, coil assemblies can be electrically coupled in series to the load in groups of one or more coil assemblies.

FIG. 10B shows a configuration for an inline electro-mechanical power converter 500 in accordance with some embodiments, wherein a first set of coil assemblies 504 are configured to generate a different current and/or voltage than a second set of coil assemblies 508. For example, the coil assemblies 504 can include more windings than the coil assemblies 508.

The approaches shown in FIGS. 10A and 10B can be combined to provide a variety of different voltages and/or currents. Further, the sets of the coils can be configured to provide substantially balanced torque to the power output shaft when power is being used to drive its rotation.

In the above-described and illustrated embodiments, the inline electro-mechanical power converter is shown secured to the output shaft. In other embodiments, the inline electro-mechanical power converter can be additionally or alternatively secured to a thrust force generator, such as a propellor.

While the above-described embodiments refer to particular fuel engines that drive output shafts, other types of engines can be employed, such as hydrogen-driven engines, sustainable aviation fuel-driven engines, or alcohol fuel-driven engines.

While, in the above-described and illustrated example embodiment, the aircraft is propellor-driven for forward flight, other types of forward power drives can be employed in other embodiments.

While it would be readily understood by a person skilled in the art, the aircraft design can be used for both manned craft and unmanned craft, such as reconnaissance aircraft.

Other thrust force generators can be employed in place of a propellor. For example, in a land vehicle, a thrust force generator can be an axle that is paired with a set of wheels that apply driving force against a travel surface.

While, in the above embodiments, more than one vertical thrust fan is illustrated, it will be appreciated that in some configurations, only one vertical thrust fan may be employed. Similarly, while, in the above embodiments, the aircraft has a set of forward power drives, it will be appreciated that, in some configurations, only one forward power drive may be employed, such as a single-propellered aircraft. Further, while, in the exemplary embodiments described above, the vertical thrust fans and the forward power drives are positioned within the wings, in other embodiments, the vertical thrust fans and the forward power drives can be positioned elsewhere in the aircraft, such as, for example, in the fuselage.

It may be understood that the various aspects and features may be mixed and matched as may be appropriate. It may also be understood that the foregoing is not intended to be an exhaustive listing of aspects and features of the invention. These and other aspects and features of the invention may be understood with reference to the description which precedes, and with the aid of the illustrations provided.

Various embodiments have been described in detail. Since changes in, and/or additions to, the above-described examples may be made without departing from the nature, spirit, or scope of the invention, the invention is not to be limited to those details.

Although specific advantages have been enumerated above, various embodiments may include some, none, or all of the enumerated advantages.

Persons skilled in the art will appreciate that there are yet more alternative implementations and modifications possible, and that the above examples are only illustrations of one or more implementations. The scope, therefore, is only to be limited by the claims appended hereto and any amendments made thereto.

What is claimed is:

1. An inline electro-mechanical power converter, comprising:
a first magnet support structure connectable to at least one of a power output shaft driven by an engine and a thrust force generator, the first magnet support structure extending radially from the least one of the power output shaft and the thrust force generator and being configured to rotate directly with the at least one of the power output shaft or the thrust force generator when the first magnet support structure is connected to the at least one of the power output shaft and the thrust force generator;
a first set of magnets positioned radially on the first magnet support structure; and
a set of coil assemblies secured to a coil support frame in an annular array, the set of coil assemblies being positioned adjacent to the first set of magnets, the first set of magnets generating an electric current in the set of coil assemblies when the magnet support structure is rotated relative to the set of coil assemblies;
wherein the set of coil assemblies is connectable to a load for providing power to the load when the first magnet support structure is rotated relative to the set of coil assemblies.

2. The inline electro-mechanical power converter of claim 1, wherein the first magnet support structure is configured to be secured to the power output shaft.

3. The inline electro-mechanical power converter of claim 1, further comprising a set of cooling fans positioned to cool the set of coil assemblies.

4. The inline electro-mechanical power converter of any one of claims 1, wherein the thrust force generator is a propellor.

5. The inline electro-mechanical power converter of any one of claims 1, wherein the load is a battery bank.

6. The inline electro-mechanical power converter of claim 5, wherein the set of coil assemblies includes two or more subsets of coil assemblies of the set of coil assemblies, each of the subset of coil assemblies of the set of coil assemblies being configured to independently connect to the battery bank to recharge the battery bank in a recharging mode.

7. The inline electro-mechanical power converter of claim 6, wherein each subset of coil assemblies in the set of coil assemblies consists of one coil assembly.

8. The inline electro-mechanical power converter of claim 6, wherein a first subset of coil assemblies is configured to generate more current and/or voltage than a second subset of coil assemblies.

9. The inline electro-mechanical power converter of claim 6, wherein the set of cooling fans includes two or more subsets of cooling fans, each subset of cooling fans being powered by a corresponding subset of coil assemblies that the subset of cooling fans is positioned to cool.

10. The inline electro-mechanical power converter of claim 1, wherein the load is a battery bank, the forward power drive is configured to provide power to the battery bank in a recharging mode, and, in a drive mode, is configured to energize the set of coil assemblies to apply a torque force on the power output shaft.

11. The inline electro-mechanical power converter of claim 10, wherein the forward power drive is configured to energize the set of coil assemblies to apply a torque force on the power output shaft to start the engine.

12. The inline electro-mechanical power converter of claim 1, wherein the load is an accessory.

13. An aircraft, comprising:
an inline electro-mechanical power converter, comprising:
a first magnet support structure connected to at least one of a power output shaft driven by an engine and a thrust force generator, the first magnet support structure extending radially from the least one of the power output shaft and the thrust force generator and being configured to rotate directly with the at least one of the power output shaft or the thrust force generator;
a first set of magnets positioned radially on the first magnet support structure; and
a set of coil assemblies secured to a coil support frame in an annular array, the set of coil assemblies being positioned adjacent to the first set of magnets, the first set of magnets generating an electric current in the set of coil assemblies when the magnet support structure is rotated relative to the set of coil assemblies;
wherein the set of coil assemblies is connected to a load for providing power to the load when the first magnet support structure is rotated relative to the set of coil assemblies.

14. The aircraft of claim 13, wherein the first magnet support structure is secured to the power output shaft.

15. The aircraft of claim 13, wherein the forward power drive includes a set of cooling fans positioned to cool the set of coil assemblies.

16. The aircraft of claim 13, wherein the thrust force generator is a propellor.

17. The aircraft of claim 13, wherein the load is a battery bank.

18. The aircraft of claim 17, wherein the set of coil assemblies includes two or more subsets of the set of coil assemblies, each of the subset of the set of coil assemblies independently connecting to the battery bank to recharge the battery bank in a recharging mode.

19. The aircraft of claim 18, wherein each subset in the set of coil assemblies consists of one coil assembly.

20. The aircraft of claim 18, wherein a first subset of coil assemblies is configured to generate more current and/or voltage than a second subset of coil assemblies.

21. The aircraft of claim 18, wherein the set of cooling fans includes two or more subsets of cooling fans, each subset of cooling fans being powered by a corresponding subset of coil assemblies that the subset of cooling fans is positioned to cool.

22. The aircraft of claim 16, wherein the load is a battery bank, and wherein rotation of the first magnet support structure relative to the set of coil assemblies recharges the battery bank in a recharging mode, the aircraft further comprising a vertical thrust fan that is electrically powered by the battery bank in a drive mode.

23. The aircraft of claim 22, wherein the battery bank is smaller in capacity than required to power the vertical thrust fan during both take-off and landing.

24. An inline electro-mechanical power converter, comprising:
a first magnet support structure connectable to at least one of a power output shaft driven by an engine and a thrust force generator, the first magnet support structure extending radially from the least one of the power output shaft and the thrust force generator and being configured to rotate directly with the at least one of the power output shaft or the thrust force generator when the first magnet support structure is connected to the at least one of the power output shaft and the thrust force generator;
a first set of magnets positioned radially on the first magnet support structure; and
a set of coil assemblies secured to a coil support frame in an annular array, the set of coil assemblies being positioned adjacent to the first set of magnets, the set of coil assemblies including two or more subsets of the set of coil assemblies, each of the subset of the set of coil assemblies being configured to independently connect to one or more loads, the first set of magnets generating an electric current in each of the two or more subsets of the set of coil assemblies when the magnet support structure is rotated relative to the two or more subsets of the set of coil assemblies;
wherein the two or more subsets of the set of coil assemblies are configured to provide power to the load when the first magnet support structure is rotated relative to the set of coil assemblies in a recharging mode.

25. The inline electro-mechanical power converter of claim 24, wherein each subset of coil assemblies in the set of coil assemblies consists of one coil assembly.

26. The inline electro-mechanical power converter of claim 24, wherein a first subset of coil assemblies is configured to generate more current and/or voltage than a second subset of coil assemblies.

27. The inline electro-mechanical power converter of claim 24, wherein the first magnet support structure is configured to be secured to the power output shaft.

28. The inline electro-mechanical power converter of claim 24, further comprising a set of cooling fans positioned to cool the set of coil assemblies.

29. The inline electro-mechanical power converter of claim 28, wherein the set of cooling fans includes two or more subsets of cooling fans, each subset of cooling fans being powered by a corresponding subset of coil assemblies that the subset of cooling fans is positioned to cool.
